(19) United States
(12) Patent Application Publication
(10) Pub. No.: US 2005/0248645 A1
(43) Pub. Date: Nov. 10, 2005

(54) Method for improving the quality of ink jet printed images

(75) Inventors: Chris Jenkins, St. Louis, MO (US); Dawn Young, Glen Carbon, IL (US); Kevin Kuester, Freeburg, IL (US); Steven D. Looman, Holland, MI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Videojet Technologies Inc., Wood Dale, IL (US)

(21) Appl. No.: 11/113,712

(22) Filed: Apr. 25, 2005

Related U.S. Application Data
(60) Provisional application No. 60/566,841, filed on Apr. 30, 2004.

(51) Int. Cl. B41J 2/01

(52) U.S. Cl. 347/105; 427/402; 428/32.1

(57) ABSTRACT

Disclosed is a method for printing an image of high quality on a porous substrate comprising applying to the porous substrate, in any order, a coating composition comprising water and/or a hydrophilic organic solvent and droplets of an ink jet ink composition comprising an image producing dye dissolved in an ink solvent, wherein the ink solvent is miscible with water and/or the hydrophilic organic solvent, and the image producing dye is insoluble or poorly soluble in the coating composition, such that when the coating composition contacts the ink jet ink composition, at least a portion of the image producing dye separates from the ink jet ink composition and deposits on the surface of the porous substrate.

### CROSS-REFERENCE TO RELATED APPLICATION

This application claims the benefit of U.S. provisional patent application No. 60/566,841, filed Apr. 30, 2004, the disclosure of which is incorporated herein by reference.

### FIELD OF THE INVENTION

This invention pertains in general to a method of improving the quality of ink jet printed images, and in particular, to a method of printing images of high print quality on a porous substrate which involves treating the substrate, such as porous paper or cardboard, with a coating composition. The treatment improves, for example, the sharpness of the printed image or reduces ink bleeding.

### BACKGROUND OF THE INVENTION

Ink jet printing is a well-known technique by which printing is accomplished without contact between the printing device and the substrate on which the printed characters are deposited. Briefly described, ink jet printing involves the technique of projecting a stream of ink droplets to a surface and controlling the placement of the droplets so that the droplets form the desired printed image on that surface. This technique of noncontact printing is well suited for application of characters onto a variety of substrates including porous paper or cardboard, as well as other types of substrates.

Reviews of various aspects of ink jet printing can be found in these publications: Kuhn et al., Scientific American, April, 1979, 162-178; and Keeling, Phys. Technol., 12(5), 196-303 (1981). Various ink jet apparatuses are described in the following U.S. Pat. Nos. 3,060,429; 3,298,030; 3,373,437; 3,416,153; and 3,673,601.

Ink jet printing systems generally are of two types: continuous ink jet (CIJ) and drop-on-demand (DOD) systems. In CIJ systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field which adjusts the trajectory of each droplet in order to direct it to a gutter for recirculation or a specific location on a recording medium. In DOD systems, a droplet is expelled from an orifice directly to a position on a recording medium in accordance with digital data signals. A droplet is not formed or expelled unless it is to be placed on the recording medium.

In general, an ink jet ink composition should meet certain requirements to be useful in ink jet printing operations. These requirements relate to viscosity, resistivity, solubility, and compatibility of components and wettability of the substrate. Further, the ink must be quick drying and smear resistant, resist abrasion, and be capable of passing through the ink jet nozzle without clogging, and permit rapid cleanup of the machine components with minimum effort.

In addition, the printed images should have sufficient adhesion to the substrates. The printed images also should be sharp and well defined. The edges of the images should not be or become ragged with time. The images should not change, or unpredictably change, in dimensions after printing. Although many ink jet printing systems are available that produce reasonably good quality images, there remains a desire in the industry for a method for further improving the print quality, especially those printed in DOD systems. For example, there is a desire for a method to improve the print quality of bar codes, which require precise dimensions to be maintained over a significant period of time.

The invention provides such a method. The advantages of the invention, as well as additional inventive features, will be apparent from the description of the invention provided herein.

### BRIEF SUMMARY OF THE INVENTION

The foregoing desire has been fulfilled to a great extent by the present invention which provides a method for printing an image of high quality on a porous substrate and a method for improving the quality of a printed image. The method comprises, in an embodiment, applying to the porous substrate, in any order, a coating composition comprising water in an amount 80% or more by weight and droplets of an ink jet ink composition comprising an image producing colorant that is insoluble or poorly soluble in the coating composition. The colorant may be a dye or a pigment. The colorant may be luminescent (e.g., fluorescent or phosphorescent) or non-luminescent.

In accordance with another embodiment, the present invention provides a method for printing an image of high quality on a porous substrate, or a method for improving the quality of a printed image, comprising applying to the porous substrate, in any order, a coating composition comprising an organic solvent in an amount 65% or more by weight of the coating composition and droplets of an ink jet ink composition comprising an image producing colorant which is insoluble or poorly soluble in the coating composition. The organic solvent can be a single organic solvent or a mixture of two, three, or more miscible organic solvents.

In accordance with yet another embodiment, the present invention provides a method for printing an image of high quality on a porous substrate, or a method of improving the quality of a printed image, comprising applying, in any order, a coating composition comprising water and/or a hydrophilic organic solvent to the porous substrate and droplets of an ink jet ink composition comprising an image producing dye dissolved in an ink solvent, wherein the ink solvent is miscible with water and/or the hydrophilic organic solvent, and the image producing dye is insoluble or poorly soluble in the coating composition, such that when the coating composition contacts the ink jet ink composition, at least a portion of the image producing dye separates from the ink jet ink composition and deposits on the surface of the porous substrate.

### BRIEF DESCRIPTION OF THE DRAWINGS

FIG. 1 depicts a control bar code printed on a porous substrate where no coating composition was applied. For additional information on this Figure as well as FIGS. 2-6, see Examples 1-2.

FIG. 2 depicts a print including a barcode printed with a water precoat (water as coating composition) and a logo “MARSH” printed without a precoat. The top corners of “M” were also precoated. The effect of the precoat can be seen as improved image contrast, at the top corners of M.

FIG. 3 depicts a bar code printed on a substrate that was post-coated with water.

FIG. 4 depicts a bar code printed with a water precoat. The scanner outputs show no change in decodability or average bar width for approximately 17 hours from printing, thereby demonstrating that the ink does not bleed into the cardboard.

FIG. 5 depicts a bar code printed on a substrate precoated with water. The print is very dark and exhibits no ink bleed over a period of 12 hours.

FIG. 6 depicts an ink growth chart of a bar code as a function of time from ink jet printing. Points (♦) represent the average bar size of the code printed on an uncoated cardboard; and points (▪) represent the average bar size of the code printed on cardboard coated with water as the coating composition.

### DETAILED DESCRIPTION OF THE INVENTION

The present invention is predicated on the discovery that the quality of the ink jet image can be improved by the use of a coating composition. Without wishing to be bound by a particular theory or mechanism, it is believed that the coating composition eliminates, retards, or reduces the diffusion of the colorant, e.g., into the depths (or thickness) of the porous substrate. Ink droplets printed from ink jet ink compositions in general dry on the substrate by evaporation of the solvent therefrom and/or by the diffusion of the solvent into the underlying pores or porous matrix of the substrate. The diffusion of solvent into the substrate is more common in DOD systems since, typically, DOD ink compositions contain a high boiling solvent, e.g., a glycol, and such high boiling solvents do not evaporate rapidly under the printing conditions. It is believed that in many instances, in addition to the solvent, the colorant (e.g., dye) in the ink droplet also diffuses (or wicks) into the pores of the substrate rather than remain on the printed surface. This wicking of the colorant is believed to continue for a significant length of time, and as a result, undesirable changes in the print element dimensions and appearance, such as line thickness, darkness, sharpness, etc. occur.

In accordance with an embodiment, the present invention provides a method for printing an image of high quality on a porous substrate comprising, in any order, applying to the porous substrate a coating composition and droplets of an ink jet ink composition comprising an image producing colorant which is insoluble or poorly soluble in the coating composition. The coating composition comprises water, an organic solvent, or a mixture thereof. In an embodiment, the coating composition comprises water in an amount of 80% or more, for example, from about 85% to 100% by weight, preferably from about 90% to 100% by weight, more preferably from about 90% to 99% by weight, and even more preferably from about 95% to about 99% by weight. The water used in the coating composition can be tap water, well water, deionized water, distilled water, or any combination thereof. In a specific embodiment, the coating composition consists or consists essentially of water.

In another embodiment, the coating composition comprises an organic solvent in an amount of 65% or more, for example, from about 70% to 100% by weight, preferably from about 80% to 100% by weight, more preferably from about 90% to 100% by weight, and even more preferably from about 95% to about 99% by weight of the coating composition. The organic solvent can be one solvent or mixture of solvents. Any suitable organic solvent can be used, for example, alcohols, preferably lower alcohols (e.g., methanol, ethanol, or isopropanol), ketones, preferably lower ketones (e.g., acetone or methyl ethyl ketone), esters, preferably lower alkyl esters (e.g., ethyl acetate), amides (e.g., N-methyl-2-pyrrolidone, dimethylformamide, or dimethylacetamide), ethers, sulfoxides (e.g., DMSO), glycol ethers, preferably lower glycol ethers (e.g., 1-methoxypropanol and 1-propoxypropanol), or any combination thereof, preferably a low boiling solvent such as an alcohol, ketone, or ester, and more preferably an alcohol, e.g., ethanol. The coating composition may also contain one or more of cosolvents (e.g., water or other organic solvent(s)).

In accordance with yet another embodiment, the present invention provides a method for printing an image of high quality on a porous substrate comprising applying, in any order, a coating composition comprising water and/or a hydrophilic organic solvent to the porous substrate and droplets of an ink jet ink composition comprising an image producing dye dissolved in an ink solvent, wherein the ink solvent is miscible with water and/or the hydrophilic organic solvent, and the image producing dye is insoluble or poorly soluble in the coating composition (e.g., water and/or the hydrophilic organic solvent), such that when the coating composition contacts the ink jet ink composition, at least a portion of the image producing dye separates (e.g., phase separates or precipitates) from the ink jet ink composition and deposits on the surface of the porous substrate. In accordance with the invention, at least 50%, preferably at least 75%, and more preferably at least 90% of the dye separates and deposits on the surface of the substrate upon contact with the coating composition.

In an aspect of the above invention, the ink solvent has a solubility of from 10% or more by weight, preferably at least 25% or more by weight, and more preferably at least 50% or more by weight, in the coating composition. The image producing colorant preferably has a solubility of less than 10%, more preferably less than 5%, and even more preferably less than 1% by weight in the coating composition. Examples of hydrophilic solvents include water, glycols, glycol ethers, polyols, and lower alcohols (e.g., ethanol, propanol).

In specific embodiments of the invention, the coating composition of the invention may be water based; the ink jet ink composition may be water based or organic solvent based. The dye dissolved in the water based ink jet ink composition or the organic solvent will interact with an additive in the water based coating composition to form a precipitate or complex. In further embodiments of the invention, the coating composition may be organic solvent based, and the ink jet ink composition may be water based or organic solvent based. The dye dissolved in the water based ink jet ink composition or the organic solvent interacts (or reacts) with an additive in the organic solvent based coating composition to form an insoluble material or precipitate, e.g., a complex or other reaction product.

In a further embodiment of the method of the present invention, all or substantially all of the dye deposits on the surface of the porous substrate. In an embodiment, the ink jet ink composition comprises two hydrophilic organic solvents that are miscible with water, for example, the hydrophilic organic solvent is selected from the group consisting of lower alcohols, glycols, glycol ethers, and any combination thereof, particularly from the group consisting of methanol, ethanol, propanol, and butanol, and any combination thereof. The glycol is preferably selected from the group consisting of ethylene glycol, propylene glycol, and higher homologs thereof, and any combination thereof, and the glycol ether is preferably selected from the group consisting of ethylene glycol monoalkylether and propylene glycol monoalkylether, and higher homologs, and any combination thereof, for example, wherein the alkyl portion of the ethylene glycol monoalkylether and propylene glycol monoalkylether, and higher homologs is selected from the group consisting of methyl, ethyl, propyl, and butyl, and any combination thereof.

In a further embodiment, the present invention provides a method for improving the quality of an image printed on a porous substrate comprising applying a coating composition on the substrate and droplets of an ink composition to form the image, wherein the coating composition comprises water in an amount of about 80% by weight or more, for example, from about 85% to 100% by weight, preferably from about 90% to 100% by weight, more preferably from about 90% to 99% by weight, and even more preferably from about 95% to about 99% by weight, and the ink composition comprises an image producing colorant which is insoluble or poorly soluble in the coating composition, e.g., water. The improvement in quality can include reducing ink bleeding or feathering, increasing the sharpness of the image (e.g., edge sharpness), and/or increasing the contrast of the image.

Embodiments of the coating composition can include, in addition to water or organic solvent, one or more additives selected from the group consisting of other organic solvents, polymers, colorants, binder resins, charged resins, crosslinked resins, colloidal compounds, salts, polyols, surfactants, complexing agents, fixing agents, laking agents, non-solvents for the colorant in the ink composition, fluorescent whitening agents, and mordants. Each of the additives can be present in any suitable amount, for example, from about 0% to about 25%, preferably from about 0.1% to about 15%, and more preferably from about 1% to about 10% by weight of the coating composition.

The polymer is preferably a water-soluble polymer, such as for example, sodium carboxymethylcellulose, polyvinyl alcohol, polyethylene glycol, and hydroxypropylmethyl cellulose. The polymer can be present in an amount of from about 1% to about 25%, preferably from about 3% to about 20%, and more preferably from about 5% to about 15% by weight of the coating composition.

The colloidal compound is preferably a colloidal inorganic oxide, for example, colloidal silica or alumina. The colloidal compound can be present in an amount of from about 1% to about 15%, preferably from about 2% to about 10%, and more preferably from about 3% to about 8% by weight of the coating composition.

Any of the organic solvents discussed above can be used as the other organic solvent. Further, high boiling solvents can be used as the other solvent. The other solvent can be chosen either for its incompatibility with the dye or as a solubilizing agent for the additives. For example, if the other solvent is chosen for its incompatibility with the dye, the other solvent can be present in an amount of from about 25% to about 100%, preferably from about 75% to about 100%, and more preferably from about 90% to about 100% by weight of the coating composition. If the other solvent is chosen as a solubilizing agent for the additives, the other solvent can be present in an amount of from about 5% to about 100%, preferably from about 50% to about 100%, and more preferably from about 90% to about 100% by weight of the coating composition.

The salt is preferably a salt of a polyvalent (e.g., divalent, trivalent, or higher valent) metal, e.g., a salt of calcium, copper, nickel, magnesium, zinc, barium, aluminum, iron, and/or chromium. The salts may be composed of any suitable anion, e.g., a halide, preferably, chloride, bromide, or iodide. The salt can be present in an amount of from about 0.1% to about 20%, preferably from about 0.5% to about 15%, and more preferably from about 2% to about 10% by weight of the coating composition.

In an embodiment, the additive is a colorant, which can be a pigment, lake, or dye. An example of a dye is a red dye; the red dye is particularly suitable for providing a background color and improve signal contrast of the printed image, for example, black image. An example of a pigment is a white pigment, e.g., titanium dioxide. The colorant can be present in an amount of from about 0.5% to about 20%, preferably from about 1% to about 15%, and more preferably from about 3% to about 10% by weight of the coating composition. This is especially true for bar codes where the background color can improve the contrast between the black bars and the background. This approach provides a higher bar code grade.

The polyol can be, for example, a diol, triol, or higher hydroxylic compounds. Examples of such polyols include propanediol, butanediol, dipropylene glycol, diethylene glycol, triethylene glycol, tetraethylene glycol, and/or polyethylene glycol. The polyol can be present in an amount of from about 1% to about 50%, preferably from about 5% to about 35%, and more preferably from about 10% to about 25% by weight of the coating composition.

Any suitable binder resin can be used, for example, cellulosic resins, polyvinylpyrrolidone, acrylic resins, acidic resins, basic resins, rosin resins, styrenics, hydrocarbon resins, polyamines, vinyl resins, styrene-maleic anhydride resins, urethane resins, hydroxyaromatic resins, aldehyde resins, ketone resins, nitrile resins, or any combination thereof. The binder resin can be present in an amount of from about 0.5% to about 30%, preferably from about 1% to about 20%, and more preferably from about 3% to about 10% by weight of the coating composition.

Any suitable charged resin, a cationic, anionic, or amphoteric resin, can be used. Examples of cationic resins include polydiallyldimethylammonium halides (e.g., chloride) and copolymers of dimethylaminomethyl acrylate or methacrylate and at least one hydroxy-lower organic acrylate or methacrylate, such as hydroxymethyl acrylate or hydroxymethyl methacrylate. The charged resin can be present in an amount of from about 0.5% to about 30%, preferably from about 1% to about 20%, and more preferably from about 3% to about 10% by weight of the coating composition.

Any suitable surfactant can be used, for example, a polysiloxane surfactant. The surfactant can be present in an amount of from about 0.05% to about 10%, preferably from about 0.05% to about 5%, and more preferably from about 0.1% to about 3% by weight of the coating composition.

Any suitable complexing agent, fixing agent, laking agent, or mordant can be used. See, for example, U.S. Pat. No. 6,270,214, which discloses certain block or graft copolymers of dialkylsiloxanes and polar, hydrophilic monomers, organopolysiloxane copolymers having functional groups capable of interacting with the ink colorant, and perfluorinated polyalkoxy polymers and perfluoroalkyl surfactants; and U.S. Pat. No. 5,434,030, which discloses certain complexing, mordanting, and laking mechanisms between ionophoric polymers and anionic or cationic dyes in the context of xerographic toners. The complexing agent, fixing agent, laking agent, or mordant can be present in an amount of from about 0.5% to about 30%, preferably from about 1% to about 20%, and more preferably from about 3% to about 10% by weight of the coating composition.

The coating composition can be applied to the porous substrate by any suitable method, for example, by spray coating, ink jet printing, wiping (e.g., with a sponge, rag or cloth loaded with the coating composition), dip coating, rod coating, doctor blade coating, air knife coating, gravure coating, roll coating, reverse roll coating, slide coating, meniscus coating, bead coating, extrusion coating, curtain coating, or any combination thereof. In an embodiment, the coating composition is applied by spray coating or ink jet printing. The substrate can be coated on one or both sides. The substrate can be coated on the ink jet printing side or on the opposite side.

The coating composition can be sprayed using a spray nozzle or (compressed) air assist nozzle. The nozzle can be a single orifice nozzle or a multiple orifice nozzle. A uniform coating or coverage is applied, and this is effected by the location of the nozzle, volume of the coating composition applied, volume of air, pressure of air, and the like. For example, the pressure of air can be from about 1 psi to about 10 psi, and preferably from about 2 psi to about 4 psi; the flow rate of the coating composition can be from abut 0.1 mL/sec to about 1 mL/sec, and preferably from about 0.3 mL/sec to about 0.6 mL/sec; and the coating composition can be applied at a loading of from about 0.001 mL/sq. inch to about 0.1 mL/sq. inch, and preferably from about 0.0086 mL/sq. inch (e.g., at 2 psi) to about 0.017 mL/sq. inch (e.g., at 4 psi).

The substrate coated with a coating composition as described above can be printed with an ink composition to obtain a high quality printed images. Alternatively, a coating composition can be applied simultaneously with ink jet printing of the image or after printing the substrate with the image. In an embodiment, the ink is an ink jet ink composition, such as one that includes an organic solvent and the image producing colorant is dissolved in the organic solvent, e.g., a glycol solvent.

In accordance with the present invention, the ink composition can be applied by a CIJ printer or a DOD ink jet printer. Accordingly, the ink jet ink composition can be formulated to operate in either type of printer. For use in a CIJ printer, the ink composition preferably has a viscosity of from about 1.6 centipoises (cps) to about 7 cps at 25° C., an electrical resistivity of from about 50 ohm-cm to about 2,000 ohm-cm, and a sonic velocity of from about 1100 meters/second to about 1700 meters/second. For use in a DOD printer, the ink composition preferably has a viscosity from about 3 cps to about 30 cps at the operating temperature of the print engine (usually 25-70° C.), e.g., from about 4 cps to about 120 cps at 25° C., electrical resistivity greater than about 3 Kohms-cm, and a surface tension from about 25 to 38 dynes/cm at 25° C. Inks in this embodiment must also pass rigorous long-term stability tests that ensure that no sedimentation of the ink components occur over the life of the ink. Inks in this embodiment will also generally have boiling points greater than 200° C.

In an embodiment, the DOD ink jet ink contains one or more organic solvents, wherein the solvent(s) are selected from the group consisting of ethylene glycol, diethylene glycol, triethylene glycol, propylene glycol, dipropylene glycol, tripropylene glycol, N-methyl-2-pyrrolidinone, diethylene glycol monoalkylether triethylene glycol monoalkylether, dipropylene glycol monoalkylether, and tripropylene glycol monoalkylether, and any combination thereof, preferably wherein the alkyl portion of the diethylene glycol monoalkylether triethylene glycol monoalkylether, dipropylene glycol monoalkylether, and tripropylene glycol monoalkylether is selected from the group consisting of methyl, ethyl, propyl, and butyl.

Any suitable ink jet ink composition, for example, an ink comprising Solvent Black 3 as the colorant and glycol and glycol ether as solvents, can be used to print the images, e.g., bar codes.

The image can be of any suitable size, shape, or design, for example, a bar code. In accordance with the invention, the porous substrate can be paper, cardboard, corrugated board, fabric, film, or label. The porous substrate can be a cellulosic web or a synthetic polymeric web. Such a web, for example, made by conventional paper making techniques wherein a fibrous pulp is deposited on a wire screen and dried to form a web, contains minute pores or voids between the cellulosic fibers for absorption of liquids therein.

Advantageously, the image printed in accordance with the invention exhibits reduced ink bleed for a period of at least 12 hours or more. The present invention allows printing of high-grade codes, e.g., grade B or better. For example, one could print consistently B grades, and even A grade is possible if the reflectance of the substrate is increased, e.g., by the use of a white cardboard as the substrate. Without the use of a coating composition of the present invention, the grades would be D or C. The grades are determined by the method according to the Uniform Code Council (UCC/EAN) standards. The images have appropriate color intensity or contrast (e.g., darkness for a black colorant), and the dimensions of the images are predictable. The image has little or no wicking of the colorant over time. The edges of the image are sharp with reduced jaggedness. There is little or no feathering. Edge quality is much improved. This method of printing also provides an advantage for grading bar codes as defined by the UCC/EAN standards or commercially available scanners where print darkness and edge quality are measured parameters.

In accordance with embodiments of the invention, the porous substrate does not require to be treated with, and is free or substantially free of, a base layer, e.g., one containing inorganic particles or crosslinked resin particles, for example, for untreated cardboard. Further, in accordance with embodiments of the invention where the substrate is treated with a coating composition prior to ink jet printing, the porous substrate does not require to be dried. The coating composition (e.g., including water or solvent) is substantially or fully retained in the coated substrate.

The images printed in accordance with the present invention have one or more of the following advantages. The present invention provides a capability to keep the ink (colorant) down on the substrate with little or no movement of the ink (colorant) as a function of time. By providing a coating composition containing a dye (e.g., water and a dye such as a red dye), the reflectance of the substrate can be increased with the result that the grade of the printed image can be improved. Alternatively, or in addition, when the colorant reacts with a component of the coating composition and forms a precipitate, the reflectance of the printed image (containing the precipitate) decreases; this results in increased contrast and improves the print grade.

In an embodiment, the present invention provides a method for printing an image of high quality on a porous substrate comprising applying to the porous substrate, in any order, a coating composition consisting essentially of water and a salt of a polyvalent metal and droplets of an ink jet ink composition comprising an image producing colorant which is insoluble or poorly soluble in the coating composition. In another embodiment, the present invention provides a method for printing an image of high quality on a porous substrate comprising applying to the porous substrate, in any order, a coating composition consisting essentially of an organic solvent and a charged resin and droplets of an ink jet ink composition comprising an image producing colorant which is insoluble or poorly soluble in the coating composition. In a further embodiment, the present invention provides a method for printing an image of high quality on a porous substrate comprising applying to the porous substrate, in any order, a coating composition consisting of water and a salt of a polyvalent metal and droplets of an ink jet ink composition comprising an image producing colorant which is insoluble or poorly soluble in the coating composition. In yet another embodiment, the present invention provides a method for printing an image of high quality on a porous substrate comprising applying to the porous substrate, in any order, a coating composition consisting of an organic solvent and a charged resin and droplets of an ink jet ink composition comprising an image producing colorant which is insoluble or poorly soluble in the coating composition.

The following examples further illustrate the invention but, of course, should not be construed in any way limiting its scope.

### EXAMPLE 1

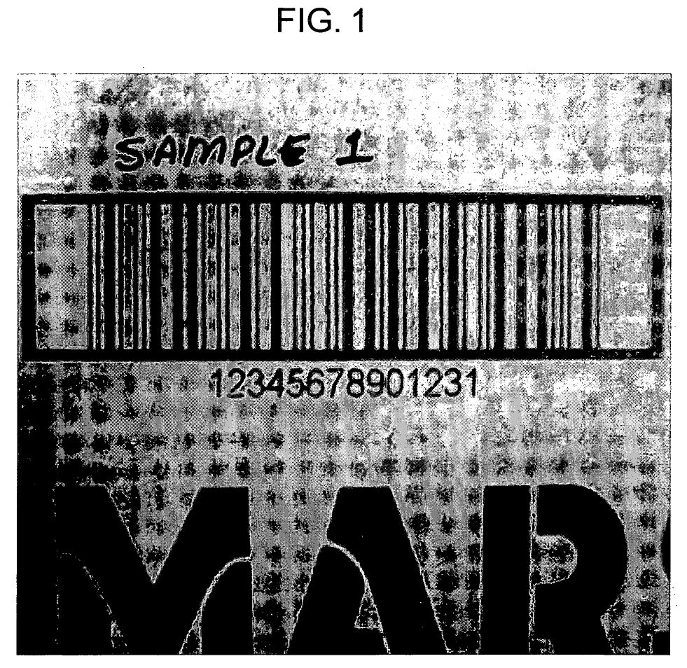

This example illustrates an advantage of an embodiment of the present invention. Water was used as the coating composition and the quality of the image printed was improved. FIG. 1 depicts a control bar code printed employing a HR300 print head at 300 dpi horizontal by 150 dpi vertical using an ink jet ink comprising Solvent Black 3 as the colorant and glycol and glycol ether as solvents on a cardboard samples were run on commercially available cardboard with the description “CARTON, RSC, SW275#, C, KRAFT”, wherein RSC stands for regular slotted carton; SW275# is the test weight; C stands for “C” flute referring to the internal glued layer; and KRAFT meaning brown paper as compared to oyster white. The same ink jet ink composition and porous substrate were used for printing the images shown in FIGS. 1-5.

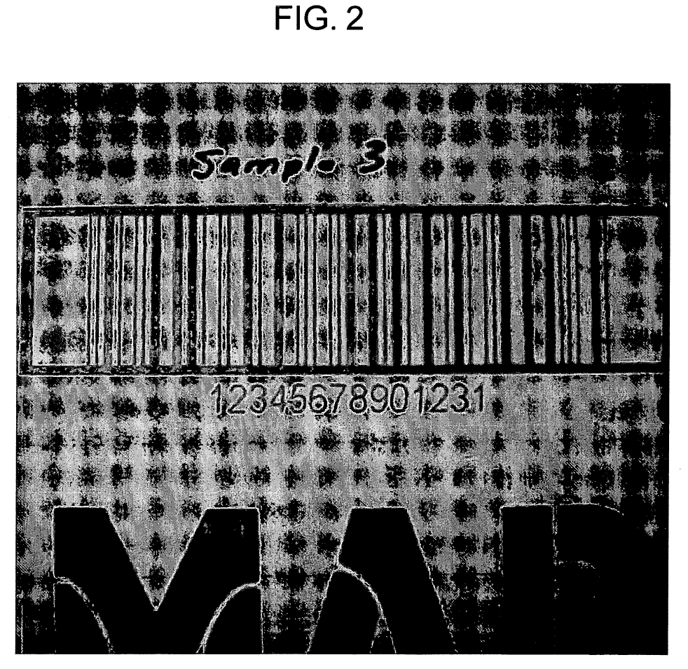

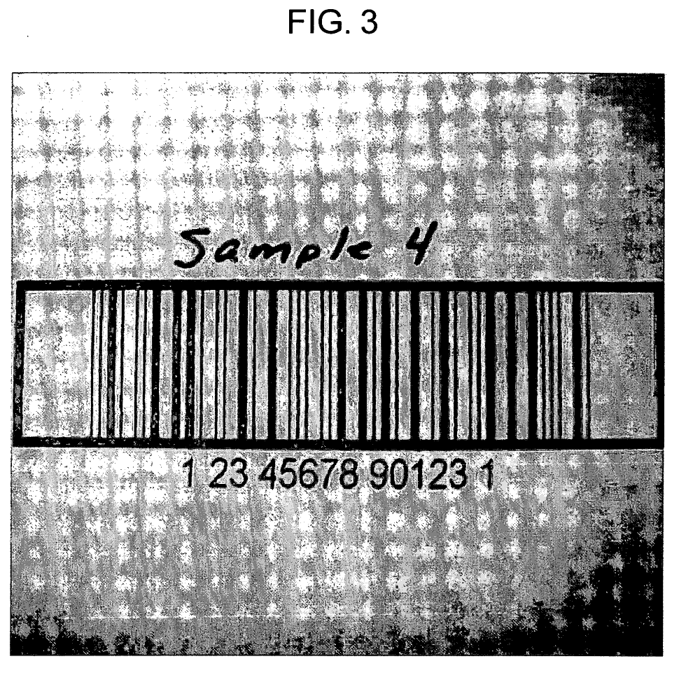

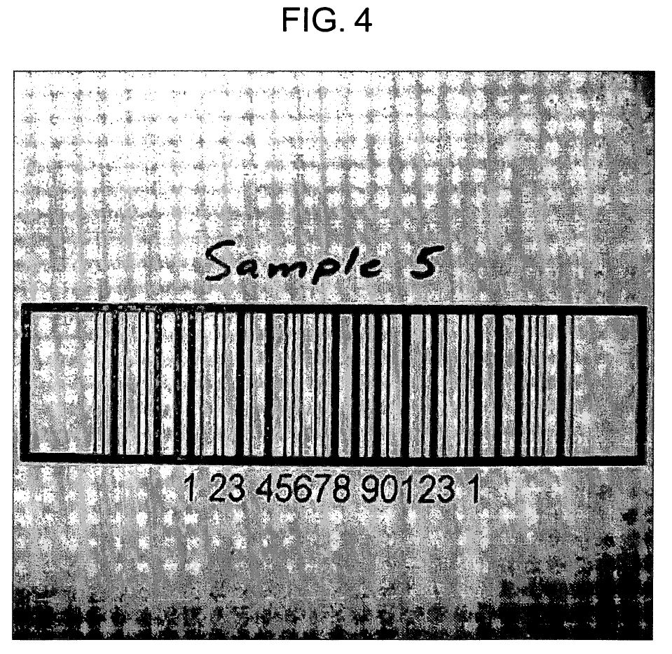

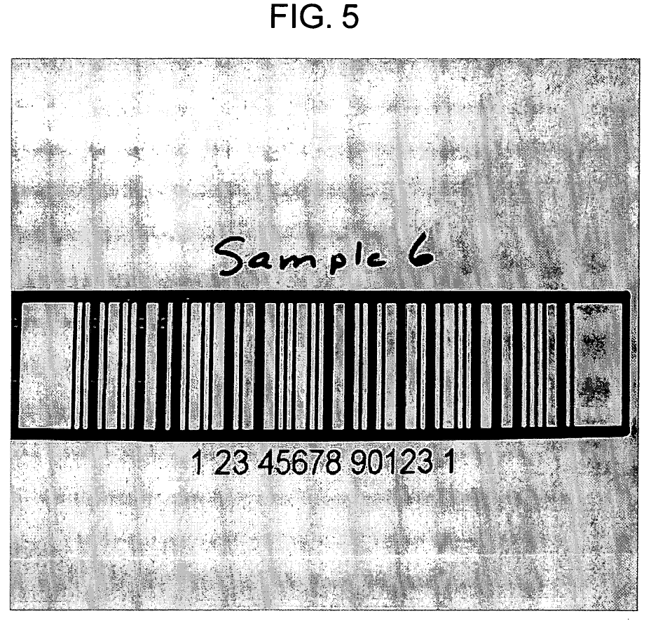

FIG. 2 depicts a print including a barcode printed with a water precoat and a logo “MARSH” printed without a precoat. The top corners of “M” were precoated. The effect of the precoat can be seen as improved image contrast, at the top corners of M. FIG. 3 depicts a bar code printed on the substrate that was post-coated with water. FIG. 4 depicts a bar code printed on the substrate with a water precoat. The scanner outputs show no change in decodability or average bar width for approximately 17 hours of time differential, thereby demonstrating that the ink does not bleed into the cardboard. FIG. 5 depicts a bar code printed on a substrate precoated with water. The print is desirably very dark and exhibits no ink bleed over 12 hours. The printer setting was 300 dpi for prints shown in all Figures except FIG. 2 where it was 150 dpi.

### EXAMPLE 2

This example illustrates an advantage of an embodiment of the present invention, namely the ink printed image does not bleed with time, and the bar code size remains unchanged.

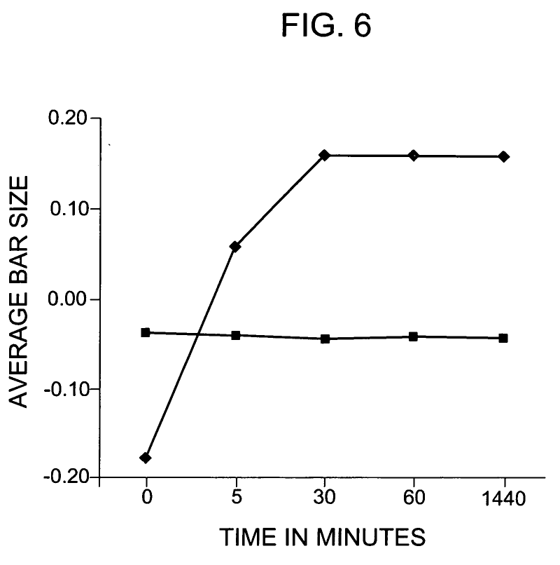

Water was employed as the coating composition on a cardboard substrate. Water coverage was 2.5×7.5 inch². A bar code was printed at 300 dpi using an ink jet ink comprising Solvent Black 3 as the colorant and glycol and glycol ether as solvents. Four samples were printed. The ink growth (or lack thereof) was determined by plotting the average bar size (as a percentage) on the Y-axis, and time in minutes from printing on the X-axis. FIG. 6 shows the results obtained. The solid curve obtained for an untreated substrate shows that the average bar size increases with time, whereas, the average bar size remains unchanged for the coated substrate. The data were taken from the bar code scanner “Average Bar Error” which compares the width of a narrow bar to 0.025 inch nominal. The negative numbers are narrower than nominal.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for printing an image of high quality on a porous substrate comprising applying to the porous substrate, in any order, a coating composition comprising water in an amount 80% by weight or more of the coating composition and droplets of an ink jet ink composition comprising an image producing colorant which is insoluble or poorly soluble in the coating composition.

2. The method of claim 1, wherein the coating composition comprises water in an amount of from about 85% to 100% by weight.

3. The method of claim 2, wherein the coating composition comprises water in an amount of from about 90% to 100% by weight.

4. The method of claim 3, wherein the coating composition comprises water in an amount of from about 95% to about 99% by weight.

5. The method of claim 1, wherein the water is tap water, well water, deionized water, distilled water, or any combination thereof.

6. The method of claim 1, wherein the coating composition includes, in addition to water, one or more additives selected from the group consisting of organic solvents, polymers, colorants, binder resins, charged resins, crosslinked resins, colloidal compounds, salts, polyols, surfactants, complexing agents, fixing agents, laking agents, non-solvents for the colorant in the ink composition, fluorescent whitening agents, and mordants, and any combination thereof.

7. The method of claim 6, wherein the polymer is a water-soluble polymer.

8. The method of claim 6, wherein the colloidal compound is a colloidal colorant.

9. The method of claim 6, wherein the salt is a salt of a polyvalent metal.

10. The method of claim 6, wherein the additive is a colorant.

11. The method of claim 10, wherein the colorant is a dye.

12. The method of claim 11, wherein the dye is a red dye.

13. The method of claim 10, wherein the colorant is a pigment.

14. The method of claim 13, wherein the pigment is a white pigment.

15. The method of claim 1, wherein the ink jet ink composition includes an organic solvent and the image producing colorant is dissolved in the organic solvent.

16. The method of claim 1, wherein the coating composition is applied to the porous substrate by spray coating, ink jet printing, wiping, dip coating, rod coating, doctor blade coating, air knife coating, gravure coating, roll coating, reverse roll coating, slide coating, meniscus coating, bead coating, extrusion coating, curtain coating, or any combination thereof.

17. The method of claim 16, wherein the coating composition is applied by spray coating or ink jet printing.

18. The method of claim 1, wherein the ink jet ink composition is a drop-on-demand ink jet ink composition.

19. The method of claim 1, wherein the ink jet ink composition is a continuous ink jet ink composition.

20. The method of claim 1, wherein the ink jet ink composition includes a drop-on-demand (DOD) ink jet ink.

21. The method of claim 20, wherein the solvent is selected from the group consisting of ethylene glycol, diethylene glycol, triethylene glycol, propylene glycol, dipropylene glycol, tripropylene glycol, N-methyl-2-pyrrolidinone, diethylene glycol monoalkylether triethylene glycol monoalkylether, dipropylene glycol monoalkylether, and tripropylene glycol monoalkylether, and any combination thereof.

22. The method of claim 21, wherein the alkyl portion of the diethylene glycol monoalkylether, triethylene glycol monoalkylether, dipropylene glycol monoalkylether, and tripropylene glycol monoalkylether is selected from the group consisting of methyl, ethyl, propyl, and butyl.

23. The method of claim 1, wherein the coating composition is applied to the porous substrate prior to applying the droplets of the ink jet ink composition.

24. The method of claim 1, wherein the coating composition is applied to the porous substrate after applying the droplets of the ink jet ink composition.

25. The method of claim 1, wherein the image is a bar code.

26. The method of claim 1, wherein the image exhibits no or substantially no ink bleed for a period of at least 12 hours after ink jet printing.

27. The method of claim 1, wherein the porous substrate is paper, cardboard, corrugated board, fabric, film, or label.

28. The method of claim 1, wherein the coating composition consists essentially of water.

29. A method for printing an image of high quality on a porous substrate comprising applying to the porous substrate, in any order, a coating composition comprising an organic solvent in an amount 65% by weight or more of the coating composition and droplets of an ink jet ink composition comprising an image producing colorant which is insoluble or poorly soluble in the coating composition.

30. The method of claim 29, wherein the coating composition comprises the organic solvent in an amount of from about 70% to about 100% by weight.

31. The method of claim 29, wherein the coating composition comprises the organic solvent in an amount of from about 80% to about 100% by weight.

32. The method of claim 29, wherein the coating composition comprises the organic solvent in an amount of from about 95% to about 99% by weight

33. A method for printing an image of high quality on a porous substrate comprising applying to the porous substrate, in any order, a coating composition comprising water and/or a hydrophilic organic solvent and droplets of an ink jet ink composition comprising an image producing dye dissolved in an ink solvent, wherein the ink solvent is miscible with water and/or the hydrophilic organic solvent, and the image producing dye is insoluble or poorly soluble in the coating composition, such that when the coating composition contacts the ink jet ink composition, at least a portion of the image producing dye separates from the ink jet ink composition and deposits on the surface of the porous substrate.

34. The method of claim 33, wherein the ink jet ink composition comprises two hydrophilic solvents that are miscible with water.

35. The method of claim 33, wherein all or substantially all of the dye deposits on the surface of the porous substrate.

36. The method of claim 33, wherein the hydrophilic organic solvent is selected from the group consisting of lower alcohols, glycols, glycol ethers, and any combination thereof.

37. The method of claim 36, wherein the lower alcohol is selected from the group consisting of methanol, ethanol, propanol, and butanol, and any combination thereof.

38. The method of claim 36, wherein the glycol is selected from the group consisting of ethylene glycol, propylene glycol, and higher homologs thereof, and any combination thereof.

39. The method of claim 36, wherein the glycol ether is selected from the group consisting of ethylene glycol monoalkylether and propylene glycol monoalkylether, and higher homologs, and any combination thereof.

40. The method of claim 39, wherein the alkyl portion of the ethylene glycol monoalkylether and propylene glycol monoalkylether, and higher homologs is selected from the group consisting of methyl, ethyl, propyl, and butyl, and any combination thereof.

41. A method for improving quality of an image printed on a porous substrate comprising applying, in any order, a coating composition on the substrate and droplets of an ink jet ink composition to form the image, wherein the coating composition comprises water in an amount 80% or more by weight, and the ink jet ink composition comprises an image producing colorant which is insoluble or poorly soluble in the coating composition.

42. The method of claim 41, wherein the improving quality comprises reducing ink bleeding into the substrate.

43. The method of claim 41, wherein the improving quality comprises increasing the sharpness of the image.

44. The method of claim 41, wherein the improving quality comprises increasing the contrast of the image.

45. The method of claim 41, wherein the coating composition comprises water in an amount of from about 85% to 100% by weight.

46. The method of claim 45, wherein the coating composition comprises water in an amount of from about 90% to 100% by weight.

47. The method of claim 46, wherein the coating composition comprises water in an amount of from about 95% to about 99% by weight.

48. The method of claim 41, wherein the water is tap water, well water, deionized water, distilled water, or any combination thereof.

49. A method for printing an image of high quality on a porous substrate comprising applying to the porous substrate, in any order, a coating composition consisting essentially of water and a salt of a polyvalent metal and droplets of an ink jet ink composition comprising an image producing colorant which is insoluble or poorly soluble in the coating composition.

50. A method for printing an image of high quality on a porous substrate comprising applying to the porous substrate, in any order, a coating composition consisting essentially of an organic solvent and a charged resin and droplets of an ink jet ink composition comprising an image producing colorant which is insoluble or poorly soluble in the coating composition.

51. A method for printing an image of high quality on a porous substrate comprising applying to the porous substrate, in any order, a coating composition consisting of water and a salt of a polyvalent metal and droplets of an ink jet ink composition comprising an image producing colorant which is insoluble or poorly soluble in the coating composition.

52. A method for printing an image of high quality on a porous substrate comprising applying to the porous substrate, in any order, a coating composition consisting of an organic solvent and a charged resin and droplets of an ink jet ink composition comprising an image producing colorant which is insoluble or poorly soluble in the coating composition.
